(19) United States
(12) Patent Application Publication
(10) Pub. No.: US 2006/0255159 A1
(43) Pub. Date: Nov. 16, 2006

(54) Power supply circuit in IC chip for non-contact IC card

(75) Inventors: Shiro Sugimura, Kanazawa-shi (JP); Hideki Kobayashi, Kanazawa-shi (JP); Shuhei Taniguchi, Nomi-shi (JP)

Correspondence Address: LACKENBACH SIEGEL, LLP, LACKENBACH SIEGEL BUILDING, 1 CHASE ROAD, SCARSDALE, NY, 10583, US

(73) Assignee: FEC Co., Ltd.., and the Government of Malaysia

(21) Appl. No.: 11/126,619

(22) Filed: May 11, 2005

(51) Int. Cl. G06K 19/06; G06K 7/08

(52) U.S. Cl. 235/492; 235/451

(57) ABSTRACT

The capacitance of a smoothing capacitor is reduced, and the size of an IC chip is minimized. A series transistor is provided on the output side of a diode which rectifies the output voltage of an antenna, and the smoothing capacitor is connected to the base of the series transistor. If the current gain of the series transistor T is β, then the apparent capacitance of the smoothing capacitor C2 is multiplied by β.

### BACKGROUND OF THE INVENTION

1. Field of the Invention

This invention relates to a power supply circuit in an IC chip for a non-contact IC card, and in particular relates to a power supply circuit in an IC chip for a non-contact IC card enabling smaller capacitance of the smoothing capacitor and reduced IC chip size.

2. Description of the Related Art

Non-contact IC cards are widely used. Such cards incorporate an IC chip having memory functions and communication functions into a card or sheet of base material, and are capable of wireless data exchange with a reader/writer. However, what are here called IC cards comprise, in addition to so-called IC cards and IC tags, paper currency, securities and similar incorporating IC chips.

Normally, the IC chip in an IC card receives carrier radio waves from the reader/writer, and rectifies the waves to generate an operating power supply voltage (as for example in Japanese Patent Laid-open No. 2002-99886).

When using this technology of the prior art, there is often the problem that, if the frequency of the carrier radio wave from the reader/writer is low, the required capacitance of the smoothing capacitor is large, and so the capacitor cannot be mounted in the IC chip. For example, if the frequency of the carrier radio wave is 13.56 MHz, the capacitance of the smoothing capacitor is required to be 100 pF or greater, and it is physically impossible to mount a capacitor with such a large capacitance on an IC chip measuring approximately 0.5 mm on a side.

Hence one object of this invention is, in light of the above problem of the prior art, to provide a power supply circuit in an IC chip for non-contact IC cards having a smaller smoothing capacitor capacitance and which can be mounted without difficulty in an IC chip, even when the frequency of the reader/writer carrier radio wave is low.

### SUMMARY OF THE INVENTION

In order to achieve this object, a configuration of this invention comprises an antenna, a diode for rectifying the output voltage of the antenna, a series transistor inserted on the output side of the diode, and a smoothing capacitor connected to the base of the series transistor; the smoothing capacitor is mounted integrally on the IC chip together with the main portion having memory functions and communication functions.

The smoothing capacitor can have a capacitance of order several pF, and can be realized by stray capacitance in the circuit.

Further, a supplementary transistor to supply a base current may be provided as an adjunct to the series transistor; the supplementary transistor may have voltage-limiter functions.

Further, the output side of the diode may be connected to the output side of another diode for rectifying the output voltage of an external antenna.

By means of the configuration of this invention, the smoothing capacitor connected to the base of the series transistor need only have capacitance equal to 1/β of the capacitance of the smoothing capacitor when a series transistor is not used (where β is the current gain of the series transistor). That is, the series transistor increases the equivalent capacitance of the smoothing capacitor, so that a satisfactory ripple reduction effect can be obtained; when the carrier radio wave frequency for the reader/writer is 13.56 MHz, the capacitance of the smoothing capacitor required in the prior art, of 100 pF or greater, can be reduced to the order of several pF, so that the capacitor can easily be mounted integrally on the IC chip. Further, such a low-capacitance smoothing capacitor can also be realized as stray capacitance in the circuitry within the IC chip.

A supplementary transistor provided as an adjunct to the series transistor supplies the base current to the series transistor, and improves the stability of operation overall. A supplementary transistor can also realize voltage-limiter functions by limiting the base voltage to a fixed voltage.

If another diode is provided to rectify the output voltage of an external antenna, the carrier radio wave received from the reader/writer via the external antenna can also be utilized as an operating power supply voltage, so that the distance over which communication with the reader/writer is performed can be increased. The external antenna is incorporated within the base material and connected to a terminal provided on the IC chip.

### BRIEF DESCRIPTION OF THE DRAWINGS

FIG. 1 is an overall system diagram; and,

FIG. 2 is a system diagram showing principal portions in another aspect.

### DESCRIPTION OF THE PREFERRED EMBODIMENTS

Below, aspects of the invention are explained using the drawings.

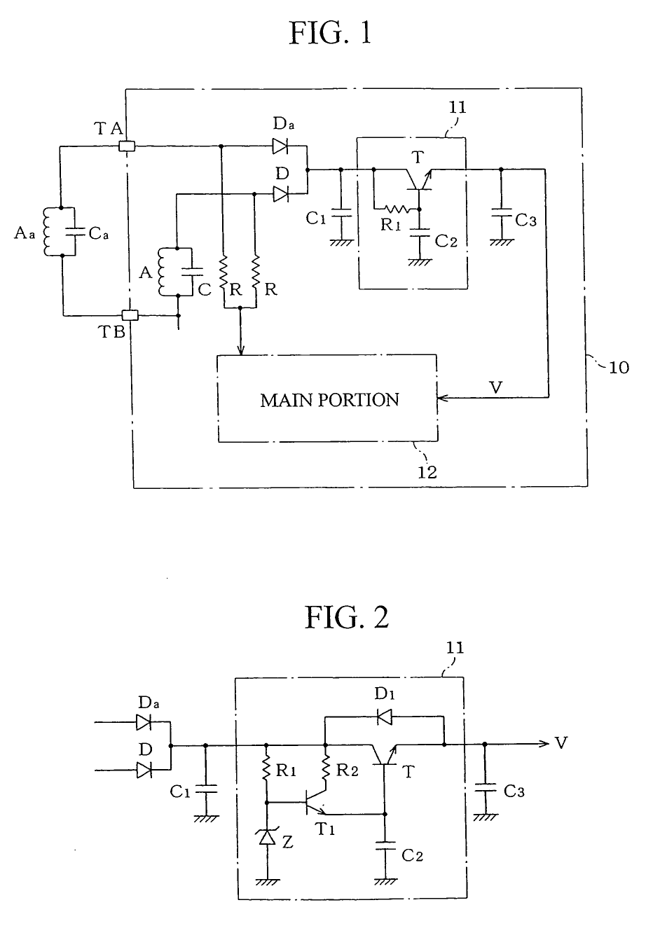

A power supply circuit in an IC chip for a non-contact IC card comprises an antenna A, diode D, series transistor T, and smoothing capacitors C1, C2, C3 (FIG. 1), and is formed integrally on an IC chip 10 together with a main portion 12 having memory functions and communication functions.

The antenna A is connected to a capacitor C for parallel resonance; the end of the antenna A on the ungrounded side is connected through the diode D to the collector of the series transistor T. The output side of the diode D is connected through the terminal TA to the output side of another diode Da connected to the end on the ungrounded side of an external antenna Aa, and is also connected to a smoothing capacitor C1. A resistance R1 is connected between the collector and base of the series transistor T, and a smoothing capacitor C2 is connected to the base of the series transistor T. The output side of the series transistor T, that is, the emitter, is connected to a smoothing capacitor C3, and the emitter of the series transistor T is connected to the main portion 12.

The inputs of the diodes D and Da are connected, via coupling resistances R, R, are combined and connected to the main portion 12. The external antenna Aa is connected to a capacitor Ca for parallel resonance, and the grounded end of the external antenna Aa is connected through the terminal TB to the grounded end of the antenna A.

When a carrier radio wave from a reader/writer, not shown, arrives at one or both of the antenna A and the external antenna Aa, the output voltages of the antenna A and external antenna Aa are rectified by the diodes D, Da, and are smoothed by the smoothing capacitor C1. On the other hand, the series transistor T acts as the equivalent of a smoothing capacitor with capacitance equal to P times the capacitance of the smoothing capacitor C2 (where β is the current gain of the series transistor T), connected in parallel with the smoothing capacitor C3. Hence even when the frequency of the carrier radio wave from the reader/writer is 13.56 MHz, the capacitance of the smoothing capacitor C2 need only be, at most, of order several pF. The smoothing capacitors C1 and C3 are supplementary, and each need only be of order several pF.

Hence each of the smoothing capacitors C1, C2, C3 can easily be realized as stray capacitances of the circuitry within the IC chip 10, without the need to take special steps to form capacitor devices within the IC chip 10. Moreover, a sufficiently stable operating power supply voltage V is generated on the output side of the series transistor T, so that power can be supplied to the main portion 12.

In FIG. 1, the circuit 11 comprising the series transistor T may also be configured with a supplementary transistor T1 added (FIG. 2).

The base and collector of the supplementary transistor T1 are connected through the resistors R1 and R2 respectively to the collector of the series transistor T, and the base of the supplementary transistor T1 is connected through a Zener diode Z to ground. The emitter of the supplementary transistor T1 is connected to the base of the series transistor T. Moreover, a protection diode D1 is connected between the collector and emitter of the series transistor T.

The supplementary transistor T1 realizes a voltage limiter function through the Zener diode Z, and in addition supplies a base current to the series transistor T, and so can increase the effective current gain of the series transistor T, and can contribute to stabilization of operation.

In the above explanation, the external antenna Aa and capacitor Ca connected to the terminals TA and TB are effective for broadening the distance of communication with the reader/writer. An external antenna Aa and capacitor Ca should be provided as necessary.

What is claimed is:

1. A power supply circuit in an IC chip for a non-contact IC card, comprising:
an antenna;
a diode, which rectifies the output voltage of said antenna;
a series transistor, inserted at the output side of said diode; and,
a smoothing capacitor, connected to the base of said series transistor; and wherein
said smoothing capacitor is formed integrally on the IC chip, together with a main portion having memory functions and communication functions.

2. The power supply circuit in an IC chip for a non-contact IC card according to claim 1, wherein said smoothing capacitance has a capacitance on the order of several picofarads.

3. The power supply circuit in an IC chip for a non-contact IC card according to claim 1 or claim 2, wherein said smoothing capacitor is realized through stray capacitance of circuitry.

4. The power supply circuit in an IC chip for a non-contact IC card according to claim 1, wherein a supplementary transistor supplying a base current is provided as an adjunct to said series transistor.

5. The power supply circuit in an IC chip for a non-contact IC card according to claim 4, wherein said supplementary transistor has a voltage-limiter function.

6. The power supply circuit in an IC chip for a non-contact IC card according to claim 1, wherein the output side of said diode is connected to the output side of another diode which rectifies the output voltage of an external antenna.
